(19) United States
(12) Patent Application Publication
(10) Pub. No.: US 2021/0110359 A1
(43) Pub. Date: Apr. 15, 2021

(54) DYNAMIC VIRTUAL RESOURCE MANAGEMENT SYSTEM

(71) Applicant: BANK OF AMERICA CORPORATION, Charlotte, NC (US)

(72) Inventors: Kathryn Elizabeth Outlaw, New York, NY (US); Ayeesha Sachedina, New York, NY (US); Nikil Manjesh Suresh Nanjundayya, London (GB)

(73) Assignee: BANK OF AMERICA CORPORATION, Charlotte, NC (US)

(21) Appl. No.: 16/601,893

(22) Filed: Oct. 15, 2019

(51) Int. Cl. G06Q 20/06; G06N 20/00

(52) U.S. Cl. CPC G06Q 20/065; G06N 20/00

(57) ABSTRACT

Embodiments of the present invention provide for the generation and management of a virtual resource account mechanism that supports a varied set of resource types and reduces the time, complexity, and cost associated with maintaining multiple resource accounts in different regions. The present invention is generally related to configuring one or more virtual resource accounts and, more specifically, providing for selection of resource amounts of different resource types prior to or in conjunction with initiation of a resource action. Conversion rate(s) used to determine the resource amount(s) is defined at the onset of the resource event, and a consistency of resource transfer activity is supported by a simplified virtual resource account structure with a singular user resource account identifier.

### FIELD OF THE INVENTION

The present invention is generally related to configuring one or more virtual resource accounts and, more specifically, providing for selection of resource amounts of different resource types prior to or in conjunction with initiation of a resource transfer. Conversion rate(s) used to determine the resource amount(s) is defined at the onset of the resource event, and a global consistency of resource transfer activity is supported by virtual resource accounts.

### BACKGROUND

Typically, maintaining accounts in various regions and jurisdictions can be a complex and costly endeavor for consumers and entities that may wish to hold resources in various different forms, such as one or more currencies. Additionally, the ability for users and entities to establish these accounts, transact between the accounts, and track expenses, costs, exchange rates, and dividends from these accounts may be complex. Furthermore, the entities maintaining the accounts may be subject to different internal protocols, regulatory requirements, and customer policies, and may also employ differing user interfaces and systems for account access that make interactions between accounts in differing regions a slow, complicated, and arduous process for all parties involved.

Therefore, a need exists to develop systems, methods, computer program products and the like that provide for more uniformity and increase ease of access to multiple resource accounts, and provide more certainty as to the volume of resources required to conduct a resource event that requires conversion from one resource type to another. In addition, a need exists to develop systems, methods, computer program products and the like that allow entities entering into a resource event to select, at the onset of resource event, between application of a known conversion rate applied at the onset of the resource event or an unknown conversion rate applied at or near the conclusion of the resource event.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address these and/or other needs by providing an innovative system, method and computer program product for the generation of a virtual resource account mechanism that supports a varied set of resource types and reduces the time, complexity, and cost associated with maintaining multiple resource accounts in different regions. In particular, the use of one or more virtual accounts supported under a single user resource account allows for the storage of differing resource types in a collectively managed user resource account. Virtual resource accounts provided by the resource management platform are each assigned a unique virtual account identifier that provides users with the ability to conduct resource transfers and resource actions from the virtual resource accounts as local transactions, as opposed to the traditional method of maintaining multiple accounts in different regions. This approach obviates the need for cross border payments, and allows for the avoidance of additional fees, costs, and time constraints associated with such cross-border transactions. Additionally, the invention provides for artificially intelligent analysis of external data in conjunction with historical user data in order to provide tailored recommendations for resource management among one or more virtual accounts. The dynamic virtual resource management system generally comprises: receiving a first resource amount for a first resource type; receiving a second resource amount for a second resource type; integrating the first resource amount for the first resource type and the second resource amount for the second resource type into a user resource account, wherein the user resource account comprises one or more virtual resource accounts corresponding to differing resource types; providing a user resource account summary to a user via a user device; and allowing the user to initiate a user resource action using the single user resource account identifier to transfer resources to and from the one or more virtual resource accounts on the user resource account platform.

In some embodiments, the resource account summary comprises a real-time resource balance for each of the one or more virtual resource accounts.

In some embodiments, the invention is further configured to: allow the user to select a base resource type; retrieve a current exchange rate for each of the differing resource types for the one or more virtual resource accounts with respect to the selected base resource type; calculate a total user resource account balance in the base resource type based on the current exchange rate for each of the different resource types; generate a total resource amount in the base resource type; and provide the total resource amount in the user resource account summary.

In some embodiments, the virtual resource accounts are each identified using a unique assigned virtual resource account identifier.

In some embodiments, the invention is further configured for: receiving a request for a resource action from the user; calculating a resource payment amount for the resource action in each of the resource types for the virtual accounts in the user account; generating an alert summarizing the resource payment amount for the resource action in each of the resource type for the virtual accounts in the user account; and transmitting the alert to the user device.

In some embodiments, the user resource account summary further comprises a graphical depiction of the user account indicating the percentage breakdown of virtual account resource value in relation to the total amount of resources available in the user resource account.

In further embodiments, the user resource management platform is further configured to analyze user resource management history data via an artificial intelligence engine; determine a pattern of user behavior regarding movement of resources between virtual accounts; and generate a user preference recommendation, wherein the user preference recommendation includes an option to implement an automated rule for movement of resources between virtual accounts.

In further embodiments, the invention is further configured for allowing the user to select a base resource type; retrieving a current exchange rate for each of the differing resource types for the one or more virtual resource accounts with respect to the selected base resource type; identifying the most favorable exchange rate among the virtual resource accounts; and providing a recommendation to the user for conversion of the first resource type or the second resource type based on the identified most favorable exchange rate.

### BRIEF DESCRIPTION OF THE DRAWINGS

Having thus described embodiments of the invention in general terms, reference will now be made to the accompanying drawings, wherein:

FIG. 1 provides a system environment, in accordance with one embodiment of the invention;

FIG. 2 provides a block diagram of a user device, in accordance with one embodiment of the invention;

FIG. 3 provides a block diagram of the resource management platform, in accordance with one embodiment of the invention;

FIG. 4 provides an illustration of the user resource account details presented to the user, in accordance with one embodiment of the present invention; and

FIG. 5 provides a schematic of a system for dynamic resource conversion and processing, in accordance with embodiments of the present invention.

### DETAILED DESCRIPTION OF EMBODIMENTS OF THE INVENTION

Embodiments providing an innovative system, method and computer program product for the generation of a virtual resource account mechanism that supports a varied set of resource types and reduces the time, complexity, and cost associated with maintaining multiple resource accounts in different regions. In particular, the use of one or more virtual accounts supported under a single user resource account allows for the storage of differing resource types in a collectively managed user resource account. Virtual resource accounts provided by the resource management platform are each assigned a unique virtual account identifier that provides users with the ability to conduct resource transfers and resource actions from the virtual resource accounts as local transactions, as opposed to the traditional method of maintaining multiple accounts in different regions. This approach obviates the need for cross border payments, and allows for the avoidance of additional fees, costs, and time constraints associated with such cross-border transactions. Additionally, the invention provides for artificially intelligent analysis of external data in conjunction with historical user data in order to provide tailored recommendations for resource management among one or more virtual accounts.

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

As used herein, the term “user” may refer to any entity or individual associated with the collaborative machine learning system. In some embodiments, a user may be a computing device user, a phone user, a mobile device application user, a business owner, a customer of an entity or business, a system operator, and/or employee of an entity (e.g., a financial institution or other business). In certain embodiments, the invention may include multiple users in the form of businesses that are transferring resources or which hold accounts with the entity system (e.g. business to business, or “B2B” transactions). In a specific embodiment, a user may be a managing user of a machine learning model, wherein the system enables the user to reconfigure the model based on user-specified criteria and policies. In another specific embodiment, a user may be a customer accessing a user account via an associated user device, wherein data from an interaction between the user and an entity is analyzed or processed by the system. In some embodiments, identities of an individual may include online handles, usernames, identification numbers (e.g., Internet protocol (IP) addresses), aliases, family names, maiden names, nicknames, or the like. In some embodiments, the user may be an individual or an organization (i.e., a charity, business, company, governing body, or the like).

As used herein the term “user device” may refer to any device that employs a processor and memory and can perform computing functions, such as a personal computer or a mobile device, wherein a mobile device is any mobile communication device, such as a cellular telecommunications device (i.e., a cell phone or mobile phone), a mobile Internet accessing device, or other mobile device. Other types of mobile devices may include laptop computers, tablet computers, wearable devices, cameras, video recorders, audio/video player, radio, global positioning system (GPS) devices, portable digital assistants (PDAs), pagers, mobile televisions, gaming devices, or any combination of the aforementioned. The device may be used by the user to access the system directly or through an application, online portal, internet browser, virtual private network, or other connection channel.

As used herein, the term “entity” may be used to include any organization or collection of users that may interact with the dynamic resource management system. An entity may refer to a business, company, or other organization that either maintains or operates the system or requests use and accesses the system. In one embodiment, the entity may be a financial institution or a payment processing entity. The terms “entity” and “financial entity” may be used to include any organization that processes financial transactions including, but not limited to, banks, credit unions, savings and loan associations, investment companies, stock brokerages, asset management firms, insurance companies and the like. In other embodiments, an entity may be a business, organization, a government organization or the like that is not a financial institution.

To “monitor” is to watch, observe, or check something for a special purpose over a period of time. The “monitoring” may occur periodically over the period of time, or the monitoring may occur continuously over the period of time. In some embodiments, a system may actively monitor a data source, data stream, database, or data archive, wherein the system reaches out to the database and watches, observes, or checks the database for changes, updates, and the like. In other embodiments, a system may passively monitor a database or data stream, wherein the database or data stream provides information to the system and the system then watches, observes, or checks the provided information. In some embodiments, “monitoring” may further comprise analyzing or performing a process on something such as a data source or data stream either passively or in response to an action or change in the data source or data stream. In a specific embodiment, monitoring may comprise continuously analyzing received payment processing or resource transfer data.

As used herein, an “interaction” may refer to any action or communication between users, entities, or institutions, and/or one or more devices or systems within the system environment described herein. For example, an interaction may refer to a user interaction with a system or device, wherein the user interacts with the system or device in a particular way. In one embodiment, interactions may be received or extracted from a data stream (e.g., in real-time). An interaction may include user interactions with a user interface (e.g., clicking, swiping, text or data entry, and the like), authentication actions (e.g., signing-in, username and password entry, PIN entry, and the like), account actions (e.g., account access, fund transfers, and the like) and the like. In another example, an interaction may refer to a user communication via one or more channels (i.e., phone, email, text, instant messaging, brick-and-mortar interaction, and the like) with an entity and/or entity system to complete an operation or perform an action with an account associated with user and/or the entity.

As used herein, the term “resource account” may refer to an account located at or maintained by an entity that is used to store one or more types of resources, such as one or more currencies, for one or more users. Furthermore, the term “resource action” may refer to any transfer of resources to or from a resource account, such as in the transfer of resources in return for goods or services, or an exchange of one resource type for another resource type. Resource actions may also include custodial actions taken by the one or more users, such as checking resource account balances, placing resource spending or withdrawal limits, or initiating the transfer of resources to settle a transaction instrument, such as a check or resource account transfer.

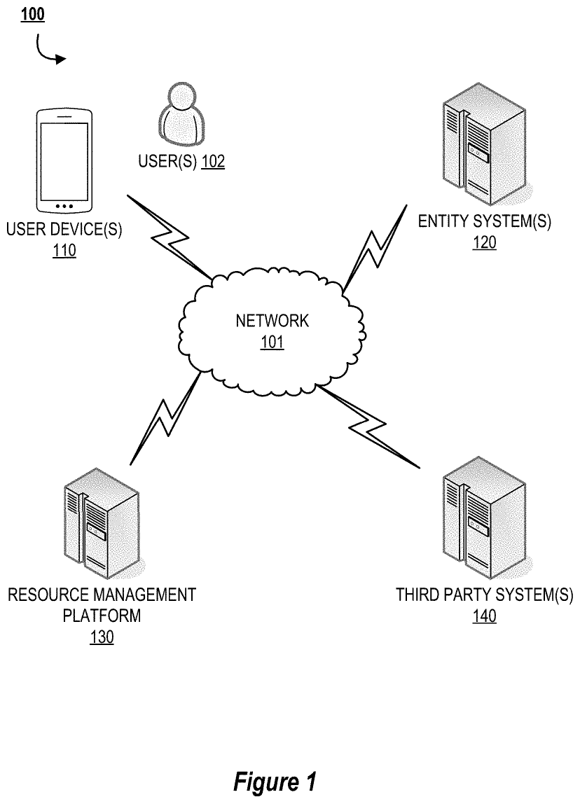

FIG. 1 provides a system environment 100, in accordance with one embodiment of the invention. As illustrated in FIG. 1, resource management platform 130 is operatively coupled, via a network 101, to the user device(s) 110 (e.g., a mobile phone, computer, laptop, tablet, terminal, automated teller machine, wearable device, and the like), third party system 140, and entity system(s) 120. While only one third party system 140, one user device 110, and one entity system 120 are depicted in the embodiment shown in FIG. 1, it is understood that the network 101 may interconnect resource management platform 130, with multiple third party systems 140, user devices 110, and entity systems 120. In this way, the resource management platform 130 can send information to and receive information from one or more user devices 110, third party systems 140 and entity systems 120. In the illustrated embodiment, the plurality of user devices 110 provide a plurality of communication channels through which the entity system 120, third party system 140, and/or the resource management platform 130 may communicate with one or more user(s) 102 over the network 101.

FIG. 1 illustrates only one example of an embodiment of the system environment 100. It will be appreciated that in other embodiments, one or more of the systems, devices, or servers may be combined into a single system, device, or server, or be made up of multiple systems, devices, or servers. It should be understood that the servers, systems, and devices described herein illustrate one embodiment of the invention. It is further understood that one or more of the servers, systems, and devices can be combined in other embodiments and still function in the same or similar way as the embodiments described herein. Non-limiting examples of applications in which the system described herein may be incorporated include mobile payment platforms, mobile wallet applications, account management platforms, investment and trading platforms, AI assistants, and the like. In some embodiments, interactions performed between the user device(s) 110 and the third party entity system 120 are intercepted and received by the resource management platform 130, wherein interaction data may be extracted from an interaction over the network 101 by the resource management platform 130 for processing or decisioning. Data monitored and/or extracted by the system may include, in a non-limiting example, user identifying information, communication history, transaction history, resource transaction identification information, authorization information, user preference data, marketing data, and the like. Data, such as user interaction data, may be acquired from across communication channels of an entity such as phone lines, text messaging systems, email, applications (e.g., mobile applications), websites, automated teller machines (ATMs), card readers, call centers, electronic assistants, instant messaging systems, interactive voice response (IVR) systems, brick-and-mortar entity or third party locations and the like.

The network 101 may be a system specific distributive network receiving and distributing specific network feeds and identifying specific network associated triggers. The network 101 may also be a global area network (GAN), such as the Internet, a wide area network (WAN), a local area network (LAN), or any other type of network or combination of networks. The network 101 may provide for wireline, wireless, or a combination wireline and wireless communication between devices on the network 101.

In some embodiments, the user 102 is an individual interacting with the entity system 120 or resource management platform 130 via a user device 110. In other embodiments, a data flow or data stream between the user device 110 and the entity system 120 is monitored by or received by the resource management platform 130 over the network 101 to be processed or analyzed. In some embodiments a user 102 is a user requesting service from the entity (e.g., customer service) or interacting with an account maintained by the entity system 120. In an alternative embodiment, the user 102 is a user interacting with, maintaining, or employing the use of virtual account management provided by the entity system 120, and supported and maintained on the resource management platform 130. In some embodiments, the resource management platform 130 may receive details of the user 102 or resource accounts that the user 102 maintains with one or more third party systems 140.

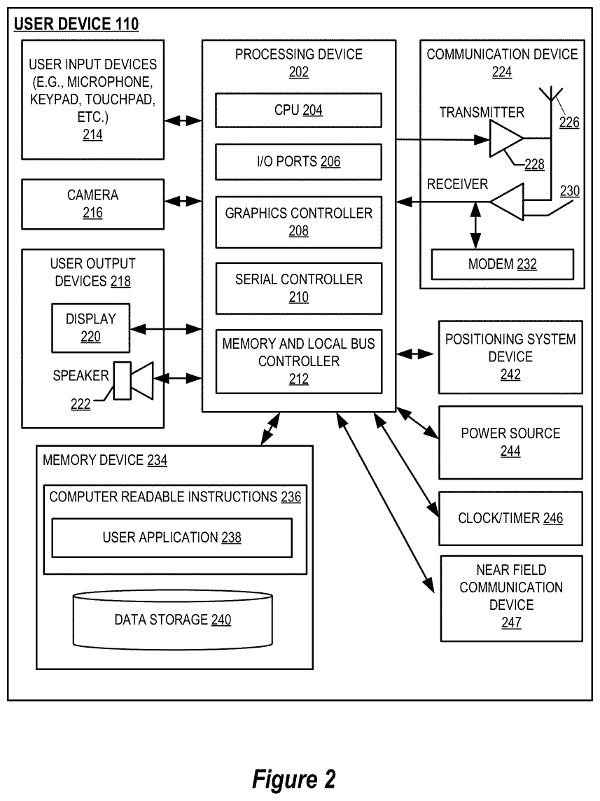

FIG. 2 provides a block diagram of the user device 110, in accordance with one embodiment of the invention. The user device 110 may generally include a processing device or processor 202 communicably coupled to devices such as, a memory device 234, user output devices 218 (for example, a user display device 220, or a speaker 222), user input devices 214 (such as a microphone, keypad, touchpad, touch screen, and the like), a communication device or network interface device 224, a power source 244, a clock or other timer 246, a visual capture device such as a camera 216, a positioning system device 242, such as a geo-positioning system device like a GPS device, an accelerometer, and the like. The processing device 202 may further include a central processing unit 204, input/output (I/O) port controllers 206, a graphics controller or graphics processing device (GPU) 208, a serial bus controller 210 and a memory and local bus controller 212.

The processing device 202 may include functionality to operate one or more software programs or applications, which may be stored in the memory device 234. For example, the processing device 202 may be capable of operating applications such as the user application 238. The user application 238 may then allow the user device 110 to transmit and receive data and instructions from the other devices and systems of the environment 100. The user device 110 comprises computer-readable instructions 236 and data storage 240 stored in the memory device 234, which in one embodiment includes the computer-readable instructions 236 of a user application 238. In some embodiments, the user application 238 allows a user 102 to access and/or interact with other systems such as the entity system 120 or resource management platform 130. In one embodiment, the user 102 is a maintaining entity of a resource management platform 130, wherein the user application enables the user 102 to define policies and reconfigure aspects of the user's resource account managed by the resource management platform 130. In one embodiment, the user 102 is a customer of a financial entity and the user application 238 is an online banking application providing access to the entity system 120 wherein the user may interact with a user resource account via a user interface of the user application 238, wherein the user interactions may be provided in a data stream as an input to the resource management platform 130. In some embodiments, the user resource account is comprised of one or more virtual resource accounts that are structured to be supported by a master virtual resource account.

The processing device 202 may be configured to use the communication device 224 to communicate with one or more other devices on a network 101 such as, but not limited to the entity system 120 and the resource management platform 130. In this regard, the communication device 224 may include an antenna 226 operatively coupled to a transmitter 228 and a receiver 230 (together a “transceiver”), modem 232. The processing device 202 may be configured to provide signals to and receive signals from the transmitter 228 and receiver 230, respectively. The signals may include signaling information in accordance with the air interface standard of the applicable BLE standard, cellular system of the wireless telephone network and the like, that may be part of the network 201. In this regard, the user device 110 may be configured to operate with one or more air interface standards, communication protocols, modulation types, and access types. By way of illustration, the user device 110 may be configured to operate in accordance with any of a number of first, second, third, and/or fourth-generation communication protocols or the like. For example, the user device 110 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The user device 110 may also be configured to operate in accordance with non-cellular communication mechanisms, such as via a wireless local area network (WLAN) or other communication/data networks. The user device 110 may also be configured to operate in accordance with audio frequency, ultrasound frequency, or other communication/data networks.

The user device 110 may also include a near field communication device 247 which is configured to securely authorize and initiate payments via the user device 110. In some embodiments, the near field communication device 247 acts in conjunction with the communication device 224 to bootstrap its transmission and receiving subcomponents, while in other embodiments the near field communication device 247 is a standalone transmitter and receiver that utilizes a low-bandwidth communication transmission to enable contactless communication for transmission of data. In some embodiments, the near field communication device 247 may be utilized to transmit user resource account information to enable contactless payment with one or more third party systems 140, such as a merchant. The near field communication device 247 may interface with user application 238 and data storage 240 in order to provide secure personal user data storage for embodiments that employ personal card information, loyalty program data, personal identification numbers, and the like. The user application 238 may provide secure communications via the near field communication device by applying encryption algorithms before data is transmitted to another device, for instance, in the case of transmitting the user's personal information for resource processing or payment.

The user device 110 may also include a memory buffer, cache memory or temporary memory device operatively coupled to the processing device 202. Typically, one or more user applications 238, are loaded into the temporarily memory during use. As used herein, memory may include any computer readable medium configured to store data, code, or other information. The memory device 234 may include volatile memory, such as volatile Random Access Memory (RAM) including a cache area for the temporary storage of data. The memory device 234 may also include non-volatile memory, which can be embedded and/or may be removable. The non-volatile memory may additionally or alternatively include an electrically erasable programmable read-only memory (EEPROM), flash memory or the like.

Though not shown in detail, the system further includes one or more entity systems 120 (as illustrated in FIG. 1) which is connected to the user device 110 and the resource management platform 130 and which may be associated with one or more entities, institutions or the like. In this way, while only one entity system 120 is illustrated in FIG. 1, it is understood that multiple networked systems may make up the system environment 100. The entity system 120 generally comprises a communication device, a processing device, and a memory device. The entity system 120 comprises computer-readable instructions stored in the memory device, which in one embodiment includes the computer-readable instructions of an entity application. The entity system 120 may communicate with the user device 110 and the resource management platform 130 to provide access to user accounts stored and maintained on the entity system 120. In some embodiments, the entity system 120 may communicate with the resource management platform 130 during an interaction with a user 102 in real-time, wherein user interactions may be monitored and processed by the resource management platform 130 in order to analyze interactions with the user 102 and reconfigure the user resource accounts in response to changes in a received or monitored data stream.

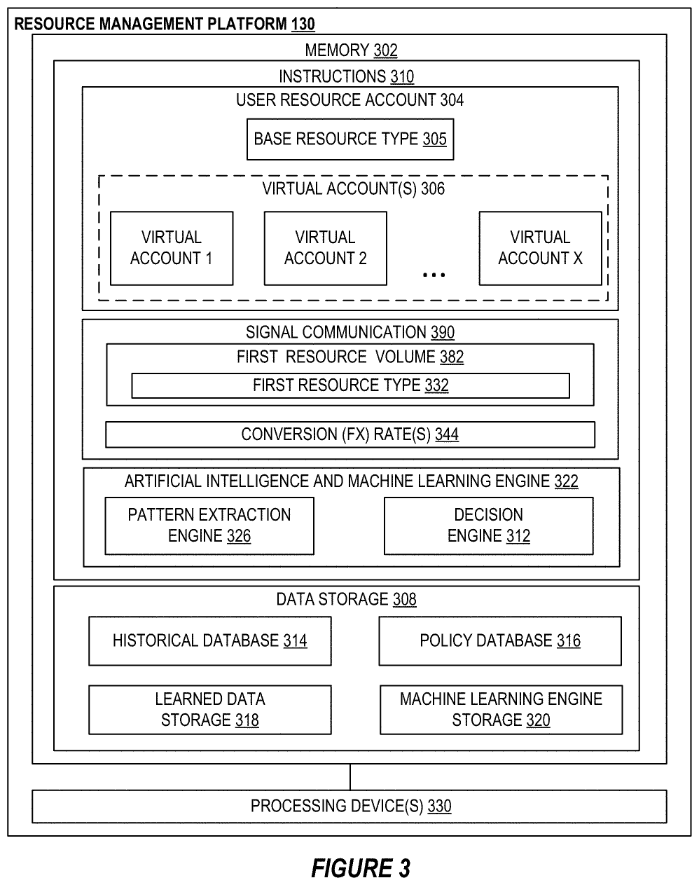

FIG. 3 provides a block diagram of the resource management platform 130, in accordance with one embodiment of the invention. Instructions 310 are configured to receive input from the user 102 that govern how the user resource account 304 is managed, viewed, and configured in the resource management platform 130. As shown, embodiments of the invention are conjured to support a user resource account 304 that includes a base resource type 305, such as a specific currency that the user 102 selects, or a specific currency based on the region that the entity systems 120 are located has adopted and regulates.

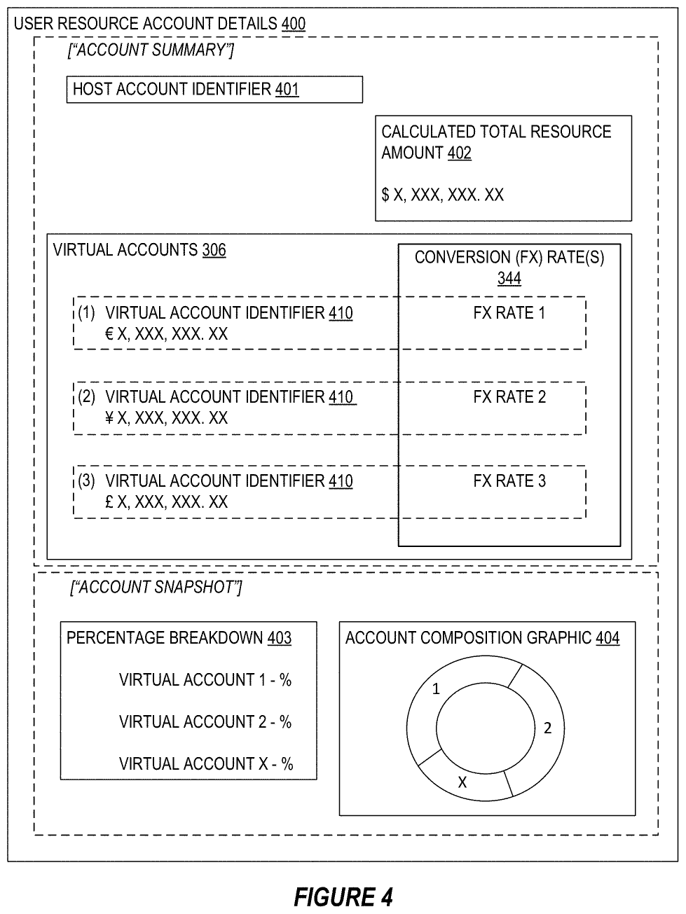

The user resource account 304 is associated with a host identifier 401, as shown in FIG. 4, such as an account number or one or more account and routing numbers, that can be used to identify the user resource account 304 and conduct resource actions which move resource into or out of the user resource account 304. Also shown are one or more virtual account(s) 306, which are represented by virtual account 1, virtual account 2, and virtual account x, wherein “account x” may be any number that coincides with the number of virtual accounts 306 that are maintained in the user resource account 304. The virtual accounts 306 are designed such that the user 102 may store resources in a resource type other than the base resource type 305 in the same user resource account 304 without the need to set up multiple separate user resource accounts 303 that would be associated with separate specific account identifiers. For instance, the various virtual accounts 306 may each correspond to a specific currency other than the base resource type 305, such as British pounds, Euros, Canadian dollars, Japanese yen, Chinese yuan, various crypto currencies, and the like. As such, the user 102 may manage a store of multiple different resource types and initiating resource actions, or transactions, in multiple resource types, using only one specific overall account identifier associated with the over arching user resource account 304.

In some embodiments of the invention, the resource management platform 130 is designed to execute a financial transaction or provide a balance of total resources or a portion of resources in the user resource account 304. This action may require determining a resource amount for a given product or determining a total resource account balance in the base resource type by applying a foreign exchange (FX) rate to the balances of the one or more virtual accounts 306. The instructions 310 are configured to generate and communicate a signal 390 to the user device 110 that is configured to present, on one or more of the user applications 238, the first resource volume 382 of the base resource type 305 and, in some embodiments of the invention, the conversion rate 344 used to determine the first resource volume 382. In specific embodiments of the invention, the first resource volume 382 that is presented on the user device 110 is volume of resources of the base resource type 305 that is equivalent to one or more of the virtual account 306 balances in the user resource account 304. In other embodiments, such as in the case for a specific resource event or transaction, the system may calculate an FX rate for a specific resource amount for the resource event, given that the resource event occurs within a predetermined time period (e.g., within a predetermined minutes or hours of presenting the first resource volume 382 on the user device or the like).

In those embodiments of the invention in which the resource event is a financial transaction, the signal communication 390 is configured to be received by the user device 110 and present to the user/payor a payment amount for the product in the user's/payor's preferred currency type (i.e., the currency type associated with the user's/payor's payment account) and, in some embodiments of the invention, the FX rate used to determine the resource payment amount of the user/payor's preferred resource type. In such embodiments of the invention, the payment amount presented to the user device may be a locked-in/guaranteed resource amount for the product, as long as the user selects to pay in the preferred resource type and the subsequent resource action occurs within a predetermined time period (e.g., predetermined minutes or hours from when the resource amount is presented on the user device).

As discussed previously, the user 102 may use the user device 110 to initiate the resource action in some instances. In some embodiments, the user may select an option using the user application 238 that initiates a resource action to transact resources from the user resource account 306 to a third party, such as via the near field communication device 247 of the user device. In other embodiments of the invention, a back-end processing device 330 may be configured to communicate a signal to the user device via a cellular network and/or the Internet. The signal may trigger the alert application 238 to display an alert on the user device or, alternatively, the signal may trigger launch of the mobile application, such as financial institution mobile application or a merchant-specific mobile application and, subsequent display of the resource action payment options within the mobile application.

As further illustrated in FIG. 3, the resource management platform 130 comprises computer-readable instructions 310 stored in the memory device 302, which in one embodiment includes the computer-readable instructions 310 of a decision engine 312, a pattern extraction engine 326, and an artificial intelligence and machine learning engine 322. In one embodiment, the artificial intelligence and machine learning engine may be utilized by the decision engine 312 and pattern extraction engine 326, to analyze behavior, transaction history, and resource management patterns of the user, as well as external data received from third party systems 140 and data related to market conditions, such as trends in foreign exchange conversion rates.

In some embodiments, the memory device 306 includes data storage 308 for storing data related to the system environment, but not limited to data created and/or used by the decision engine 312, and pattern extraction engine 326, and artificial intelligence and machine learning engine 322. Storage of data related to the system environment may include various databases such as historical database 314, policy database 316, learned data storage 318, and the machine learning engine storage 320.

The historical database 314 is used to store information regarding past interactions (e.g., account actions, transactions, communications, inputs) and/or content of a past data stream. In some embodiments, the historical interaction database 314 may be configured to store data from an incoming data stream in real-time. In some embodiments, the policy database 316 is configured to store pre-determined policies, conditions, rules, thresholds, user profile data or the like for use by the resource management platform 130 (e.g., model configurations, user demographics, and model adaptations). The policy database 316 my further be configured to store learned policies, conditions, rules, thresholds, or the like as determined in real-time by the machine learning models of the system described herein. In some embodiments, the policy database 316 is further configured to store risk metrics, system performance metrics, cost metrics, benefit metrics, cost-change metrics, adversarial scenarios or data, extrapolated scenarios or data, and the like associated with the resource management platform 130. In some embodiments, the policy database 316 and/or the historical interaction database 314 include pre-existing training data for training a machine learning or artificial intelligence engine. In some embodiments, the historical interaction database 314 further comprises historical data recorded by the resource management platform 130. This user resource management history may include how the user typically manages and transacts resources in the user resource account 304. In some embodiments, the policy database 316 is configured for storing settings associated with the system itself such as energy efficiency settings, computer resource use efficiency settings, response time settings, regulatory guidelines, and the like.

FIG. 4 provides an illustration of the user resource account details presented to the user, in accordance with one embodiment of the present invention. As depicted, the user resource account details 400 include “account summary” and “account snapshot” components which provide the user 102 with various real time information regarding the resources in their user resource account 304 and underlying virtual resource account(s) 306. The user resource account details 400 may be provided by the resource management platform 130 via a user device 110. In some embodiments, the user resource account details 400 are hosted on a secure web page accessible via a web browser on the user device 110, while in other embodiments the user resource account details may be provided on a user device 110 such as a mobile device or wearable device via the user application 238.

In order to provide the user 102 with convenient access to information about the user resource account 304, the information presented to the user 102 includes various information regarding the virtual accounts 306 and how the virtual accounts 306 contribute to the overall calculated total resource amount 402, which is displayed using the base resource type 305 as a denominator. The host account identifier 401 may include the account number for the user resource account 304, and other details that the user 102 may need to access and transact resources to and from the user resource account 304, such as routing numbers. Also shown in FIG. 4 below the virtual accounts 306 are virtual account identifier(s) 410. While the user resource account 304 is identified as a whole by the host account identifier 401, the invention includes the ability to transact resources directly to a virtual account 306, which is achieved via the use of virtual account identifiers 410. This key aspect of the invention allows each virtual account 304 to be treated and used as a local account for storing and moving resources of different resource types to and from the user resource account 304. This allows the user 102 to conduct transactions using the virtual account 306 in the form of a local account and ultimately avoid additional fees, account maintenance costs, added time constraints, and regulatory reporting hurdles typically associated with cross-border transactions, as would be the case if the user employed multiple resource accounts in differing regions.

In some embodiments, as resources are deposited to the user resource account 304, the resources may be intelligently sorted into the proper virtual account 306 associated with the given resource type deposited. In other embodiments, the resource management platform 130 may be configured by the user 102 to convert incoming resources into one or more resource types, or the base resource type 305 by default. In still further embodiments, incoming resources may be converted to a given resource type and deposited into one or more of the virtual resource accounts 306 on a case by case basis, or according to programmed rules or preferences that are set by the user 102 based on certain parameters such as resource amount or volume, sender location or identification, or a temporal component such as time of day, or day of the week, month, year, and the like. In still other embodiments, the user may program received resources to be converted and deposited into corresponding virtual accounts 306 based on conversion (FX) rate 344. For instance, the resource management platform may determine the most favorable FX rate 344 at the time of deposit based on previous FX rate 344 trends, expected FX rate 344 trends, or by comparison of current FX rates 344 between different resource types. The most favorable FX rate 344 may be communicated to the user 102 as a recommendation at the time of resource deposit, at which point the user may select the resource type corresponding with the most favorable rate.

Furthermore, in some embodiments of the invention, the user 102 may be aided in the selection of account rules via intelligent recommendations generated by the resource management platform 130. The invention achieves this via the use of artificially intelligent analysis via artificial intelligence and machine learning engine 322 of user spending habits, previously indicated user preferences, and user initiated resource actions in order to generate user-specific recommendations for resource management. In addition, the system may incorporate external data into the analysis, such as recorded trends in FX rate 344 data, forecasted FX rate trends, data received from third party systems 120 (e.g. marketing data, user preference data, data regarding populations of similar users, and the like). By use of the artificial intelligence and machine learning engine 322 and incorporated data from historical database 314 and learned data storage 318, the resource management platform 130 may generate recommendations for the user 102 and push the recommendations to the user 102 via the user device 110, at which point the user 102 may elect to implement the recommendations or tailor them to their specific preferences, at which point they may be store din the policy database 316 for future action to occur automatically.

For instance, the artificial intelligence and machine learning engine 322 may identify that the user 102 typically converts a specific resource type, such as British pounds, into euros after deposit. The artificial intelligence and machine learning engine 322 may generate a recommendation that the user set a preference to automatically convert and store British pounds into euros and store them in the appropriate virtual account 306. In another embodiment, the artificial intelligence and machine learning engine 322 may use external data to determine that the exchange rate of British pounds to another resource type other than euros may be more favorable based on perceived trends in FX rates 344, or projected trends in FX rates 344 due to the nature of news information, sentiment analysis, market information, a historical fractal pattern, and the like, and may further generate additional recommendations for the user 102 to alter the set preference to automatically convert such resources accordingly.

As shown in the “account summary” section, the virtual accounts 306 may be displayed on the user resource account details 400 individually in the resource type associated with each virtual account 306. The total balance of each virtual account and the corresponding conversion rate 344 with respect to the base resource 305 are also shown in this section for each virtual account. Also shown are the percentage breakdown 403, and account composition graphic 404, which indicate how the calculated total resource amount 402 is comprised of each virtual account at the time the user is viewing the user resource account details 400.

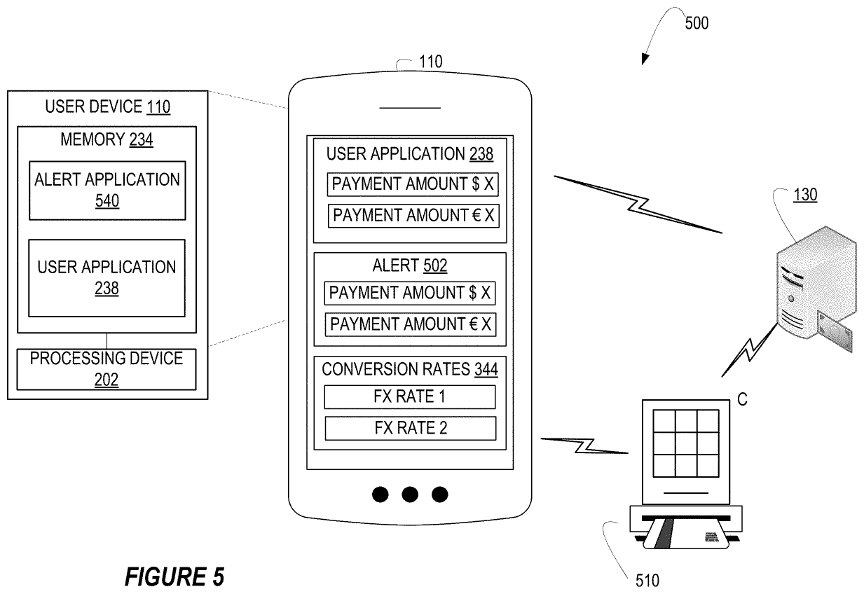

FIG. 5 provides a schematic of a system 500 for dynamic resource conversion and processing, in accordance with embodiments of the present invention. The system includes a user device 110, a POS terminal 510 and the resource management platform 130, which may act as a back end resource processing platform in this embodiment. In some embodiments, the entity systems 120 or one or more third party platforms 140 may act as the backend resource processing platform. The user device 110, which may comprise a mobile communication device, such as a smart telephone device or the like, includes a memory 234 and one or more processing devices 202 in communication with the memory 234.

The memory 234 stores alert application 540 and user application 238 that are executable by the one or more processors and configured to, in response to receiving a signal from the POS terminal 510 or the resource management platform 130, display an alert 502 that includes the resource action options or launch the mobile application 238, which displays the resource action options as resource amounts in multiple resource types, as shown. In one embodiment of the invention, the POS terminal 510 may interact directly with the user device 110, via a short-range wireless communication network/protocol, such as NFC, or the like to communicate a signal to the user device that includes the resource action options. In other embodiments of the invention, the system acting as the back-end processing platform, such as resource management platform 130, may be configured to communicate the signal to the user device via a cellular network and/or the Internet. The signal may trigger the alert application 540 to display an alert 502 on the user device or, alternatively, the signal may trigger launch of the user application 238 application, such as financial institution mobile application or a merchant-specific mobile application and, subsequent display of the resource action options within the mobile application. Also shown here in FIG. 5 are conversion rates 344. The conversion rates 344 may be displayed in this embodiment to indicate the current FX rates at the time of the resource action with regard to the one or more resource types shown in the alert 502. It is understood that while only two resource types are shown in this embodiment, the number of resource types may vary according to the number and types of virtual accounts that the user 102 maintains in the user resource account 304 at any given time.

In other embodiments, it is understood that the POS terminal 510 may be substituted with another user device 110, or may not be present at all. For instance, the user 102 may wish to transfer a certain amount of resources to a second user 102, in which case the user 102 may choose to access the user application 238 and initiate the resource action independently. In other embodiments, the user 102 may initiate a request for resource transfer from a second user 102, in which case the resource management platform 130 may initiate the alert 502 to be presented on the user device 110 of the second user 102. If the second user 102 maintains a user resource account 304 that contains virtual resource accounts 306, the resource management platform 130 may initiate an alert 502 for the second user presenting the payment amounts and conversion rates 344 accordingly. In some embodiments, the user 102 may initiate a resource action request and select options for the resource action to be completed by the second user, in which case the alert 502 generated by the resource management platform 130 and forwarded to the second user would only include the selected options for the resource action that the user 102 selects. In still other embodiments, the user 102 may be a business that would like to wire funds from one or more virtual resource accounts 306, and may unilaterally initiate this transaction without interacting with a second user 102 or additional user device 110. As such, the capabilities of the user 102 to interact with the user device 110 in order to communicate with POS terminal 510 simply represents one embodiment where the user 102 may easily interact with a merchant in order to transfer funds from the virtual resource account 306, but it is understood that the concept of accessing the virtual resource account 306 to initiate the transfer of resources does not necessarily include this configuration, but in all cases is supported and facilitated using resource management platform 130.

In some embodiments, the users involved may be multiple business entities that have virtual resource accounts 306 which are managed by the resource management platform 130. The multiple business entities may wish to transfer resources between one another to or from their respective virtual resource accounts 306. In some instances, transfer of resources between business may traditionally be completed using a bank wire, ACH payment rail, or other form of resource transfer between conventional accounts. In embodiments of the present invention, the multiple business entities may act as users 102 of the resource management platform 130 in order to transfer resources between their accounts using the various currency selection tools described herein for a B2B transaction, effectively reducing the complexity associated with managing, initiating, or completing business transactions between different currencies that may be associated with global business operations. As such, it is understood that the B2B transactions described herein may involve one or more user devices 110 utilized by the multiple businesses to initiate resource transfers via the resource management platform 130, which would not include the use of a POS terminal 510, but rather direct communication via the user devices 110 with the resource management platform 130 to complete the resource transfer or various other resource management actions as described above.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with collaborative machine learning and population reconfiguration.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for state-based learning and neural network reconfiguration, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for dynamic virtual resource management, the system comprising:
a module containing a memory storage device, a communication device, and a processor, with computer-readable program code stored thereon, wherein executing the computer-readable code is configured to cause the processor to:
receive a first resource amount for a first resource type;
receive a second resource amount for a second resource type;
integrate the first resource amount for the first resource type and the second resource amount for the second resource type into a user resource account, wherein the user resource account comprises one or more virtual resource accounts corresponding to differing resource types;
provide a user resource account summary to a user via a user device; and
allow the user to initiate a user resource action using the single user resource account identifier to transfer resources to and from the one or more virtual resource accounts on the user resource account platform.

2. The system of claim 1, wherein the resource account summary comprises a real-time resource balance for each of the one or more virtual resource accounts.

3. The system of claim 1, wherein the system is further configured to:
allow the user to select a base resource type;
retrieve a current exchange rate for each of the differing resource types for the one or more virtual resource accounts with respect to the base resource type;
calculate a total user resource account balance in the base resource type based on the current exchange rate for each of the differing resource types;
generate a total resource amount in the base resource type; and
provide the total resource amount in the user resource account summary.

4. The system of claim 1, wherein the virtual resource accounts are each identified using a unique assigned virtual resource account identifier.

5. The system of claim 1, further configured to:
receive a request for a resource action from the user;
calculate a resource payment amount for the resource action in each of the resource types for the virtual resource accounts in the user resource account;
generate an alert summarizing the resource payment amount for the resource action in each of the differing resource types for the virtual resource accounts in the user resource account; and
transmit the alert to the user device.

6. The system of claim 1, further configured to:
analyze user resource management history data via an artificial intelligence engine;
determine a pattern of user behavior regarding movement of resources between virtual accounts; and
generate a user preference recommendation, wherein the user preference recommendation includes an option to implement an automated rule for movement of resources between virtual accounts.

7. The system of claim 1, further comprising:
allow the user to select a base resource type;
retrieve a current exchange rate for each of the differing resource types for the one or more virtual resource accounts with respect to the base resource type;
identify a most favorable exchange rate among the virtual resource accounts; and
provide a recommendation to the user for conversion of the first resource type or the second resource type based on the most favorable exchange rate.

8. A computer-implemented method for dynamic virtual resource management, the computer-implemented method comprising:
receiving a first resource amount for a first resource type;
receiving a second resource amount for a second resource type;
integrating the first resource amount for the first resource type and the second resource amount for the second resource type into a user resource account, wherein the user resource account comprises one or more virtual resource accounts corresponding to differing resource types;
providing a user resource account summary to a user via a user device; and
allowing the user to initiate a user resource action using the single user resource account identifier to transfer resources to and from the one or more virtual resource accounts on the user resource account platform.

9. The computer-implemented method of claim 8, wherein the resource account summary comprises a real-time resource balance for each of the one or more virtual resource accounts.

10. The computer-implemented method of claim 8, further configured to:
allow the user to select a base resource type;
retrieve a current exchange rate for each of the differing resource types for the one or more virtual resource accounts with respect to the base resource type;
calculate a total user resource account balance in the base resource type based on the current exchange rate for each of the differing resource types;
generate a total resource amount in the base resource type; and
provide the total resource amount in the user resource account summary.

11. The computer-implemented method of claim 8, wherein the virtual resource accounts are each identified using a unique assigned virtual resource account identifier.

12. The computer-implemented method of claim 8, further comprising:
receiving a request for a resource action from the user;
calculating a resource payment amount for the resource action in each of the resource types for the virtual resource accounts in the user resource account;
generating an alert summarizing the resource payment amount for the resource action in each of the differing resource types for the virtual resource accounts in the user resource account; and
transmitting the alert to the user device.

13. The computer-implemented method of claim 8, further comprising:
analyze user resource management history data via an artificial intelligence engine;
determine a pattern of user behavior regarding movement of resources between virtual accounts; and
generate a user preference recommendation, wherein the user preference recommendation includes an option to implement an automated rule for movement of resources between virtual accounts.

14. The computer-implemented method of claim 8, further comprising:
allowing the user to select a base resource type;
retrieving a current exchange rate for each of the differing resource types for the one or more virtual resource accounts with respect to the base resource type;
identifying a most favorable exchange rate among the virtual resource accounts; and
providing a recommendation to the user for conversion of the first resource type or the second resource type based on the most favorable exchange rate.

15. A computer program product for dynamic virtual resource management, the computer program product comprising at least one non-transitory computer-readable medium having computer-readable program code portions embodied therein, the computer-readable program code portions comprising:
an executable portion configured for receiving a first resource amount for a first resource type;
an executable portion configured for receiving a second resource amount for a second resource type;
an executable portion configured for integrating the first resource amount for the first resource type and the second resource amount for the second resource type into a user resource account, wherein the user resource account comprises one or more virtual resource accounts corresponding to differing resource types;
an executable portion configured for providing a user resource account summary to a user via a user device; and
an executable portion configured for allowing the user to initiate a user resource action using the single user resource account identifier to transfer resources to and from the one or more virtual resource accounts on the user resource account platform.

16. The computer program product of claim 15, wherein the resource account summary comprises a real-time resource balance for each of the one or more virtual resource accounts.

17. The computer program product of claim 15, wherein the system is further configured to:
allow the user to select a base resource type;
retrieve a current exchange rate for each of the differing resource types for the one or more virtual resource accounts with respect to the base resource type;
calculate a total user resource account balance in the base resource type based on the current exchange rate for each of the differing resource types;
generate a total resource amount in the base resource type; and
provide the total resource amount in the user resource account summary.

18. The computer program product of claim 15, wherein the virtual resource accounts are each identified using a unique assigned virtual resource account identifier.

19. The computer program product of claim 15, further comprising:
receiving a request for a resource action from the user;
calculating a resource payment amount for the resource action in each of the resource types for the virtual resource accounts in the user resource account;
generating an alert summarizing the resource payment amount for the resource action in each of the differing resource types for the virtual resource accounts in the user resource account; and
transmitting the alert to the user device.

20. The computer-implemented method of claim 15, further comprising:
allowing the user to select a base resource type;
retrieving a current exchange rate for each of the differing resource types for the one or more virtual resource accounts with respect to the base resource type;
identifying a most favorable exchange rate among the virtual resource accounts; and
providing a recommendation to the user for conversion of the first resource type or the second resource type based on the most favorable exchange rate.
